(19) United States
(12) Patent Application Publication
(10) Pub. No.: US 2006/0236033 A1
(43) Pub. Date: Oct. 19, 2006

(54) System and method for the implementation of an adaptive cache policy in a storage controller

(75) Inventors: Kevin P. Guinn, Austin, TX (US); Peyman Najafirad, Austin, TX (US); Bharath V. Vasudevan, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/108,521

(22) Filed: Apr. 18, 2005

(51) Int. Cl. G06F 12/00

(52) U.S. Cl. 711/118

(57) ABSTRACT

A system and method for the implementation of an adaptive cache policy in a storage controller is disclosed in which a cache optimization utility monitors data access commands generated by one or more of the software applications of a server node. On the basis of one or more characteristics of the data access commands, the cache optimization utility can adjust the cache policy of the storage controller. In the case of a database application, the cache policy of the storage controller can be adjusted so that a first cache policy is applied with respect to data access commands directed to the data files of the database and a second cache policy is applied with respect to data access commands directed to transaction log files of the database.

### TECHNICAL FIELD

The present disclosure relates generally to the field of computer networks and storage networks, and, more particularly, to a system and method for the implementation of an adaptive cache policy in a storage controller.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A computer network may include a server cluster coupled to shared storage. A server cluster is a group of networked servers that are managed as a whole to provide an enhanced level of fault tolerance, scalability, and manageability. In a shared storage environment, each of the servers of the server cluster may access the shared storage resources, although only one of the servers will have logical ownership of any logical division of the shared storage resources at any one time. The shared storage resources may comprise multiple drives that are managed according to a redundant storage methodology. One example of a redundant storage methodology is a RAID storage methodology, in which a group of drives are managed as a whole to improve the performance and data redundancy of the drives. The drives of a RAID are typically controlled by a RAID storage controller which may be located in one of the server nodes or in one or more of the storage enclosures that include the drives of the RAID array or arrays.

In a non-clustered environment or in the case of external storage controller in a storage-based RAID environment, a cache in a storage controller may include a dedicated battery source as for the purpose of supplying power to the cache in the event of a failure of the server node. In the case of a storage controller that is included within the server nodes of the server cluster, the storage controller may have the capability of performing cache operations for I/O accesses to the drives of the RAID array. The use of a write-back or read-ahead caching policy in an internal storage controller may improve the performance of the network, including the performance of the RAID array. The use of a write-back cache may, however, lead to a discontinuity in the data of a RAID array. In the event of a failure of a server node, the applications of a first server node are failed over, or migrated, to a second server node of the cluster. If uncommitted or dirty data resides in the cache of the first server node, a discontinuity in the data of the RAID array will result, as the data of write commands transmitted by the first node has not yet been written back to the drives of the RAID array. Because the first server node has failed, the second server node will not have access to the uncommitted data residing in the cache of the first server node.

### SUMMARY

In accordance with the present disclosure, a system and method for the implementation of an adaptive cache policy in a storage controller is disclosed in which a cache optimization utility monitors data access commands generated by one or more of the software applications of a server node. On the basis of one or more characteristics of the data access commands, including the type or target of the commands, the cache optimization utility can adjust the cache policy of the storage controller with respect to the storage volume contained therein. In the case of a database application, for example, the cache policy of the storage controller can be adjusted so that a first cache policy is applied with respect to data access commands directed to the data files of the database and a second cache policy is applied with respect to data access commands directed to transaction log files of the database.

The system and method disclosed herein is technically advantageous because the cache policy of a storage controller for a redundant storage system can be tailored for improved performance and failover reliability on the basis of the characteristics of the data access commands being received by the storage controller. Another technical advantage of the system and method disclosed herein is the operation of the cache optimization utility is transparent with respect to the operation of the software application of the server node. Because of the transparency of the cache optimization utility, the cache policy of the storage controller can be optimized without modifying the operation of the software application of the server node. The system and method disclosed herein is also advantageous because the cache policy of the storage controller can be modified with respect to any number of characteristics of the data access commands generated by the software applications of the server node. The cache policy of the storage controller can be adaptively modified and adjusted so that a cache policy implemented that is most advantageous for the operation of the application. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a cluster that includes server nodes and a storage subsystem;

FIG. 2 is a flow diagram of a method for monitoring the issuance of data access commands and adjusting the cache policy of the storage controller in response; and

FIG. 3 is a flow diagram of a method for implementing a cache policy at a storage controller.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

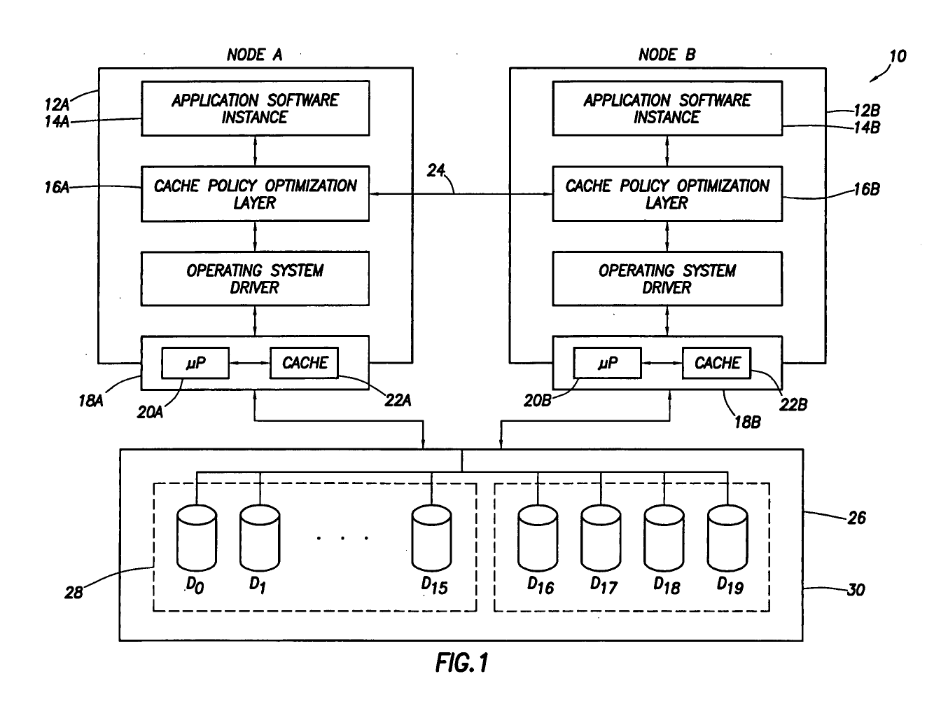

Shown in FIG. 1 is a diagram of a network, which is indicated generally at 10. Network 10 includes a server cluster, which is comprised of Server Node A at 12A and Server Node B at 12B. Each of the server nodes 12 is coupled to a storage network, which is comprised in this example of a storage enclosure 26. Each server node includes an application software instance 14 and a cache policy optimization layer 16. Each server node also includes an operating system 17, which may include a driver for the storage controller 18 of the server node. Each storage controller 18 includes a microprocessor 20 and a cache memory 22. As indicated in FIG. 1, the reference numerals for the components of Server Node A have the suffix A, and the reference numerals for the components of Server Node B have the suffix B.

Application software instance 14 may comprise any of a number of application software programs. One example is a database program, which is a software application that stores, organizes, and access data in a database format in storage. Cache policy optimization layer 16 may comprise a software utility that monitors data access commands, including read and write commands, being generated by the application software instance. A utility, as that term is used herein, refers to a software program. From the perspective of the application software instance, the cache policy optimization layer 16 is transparent, as application software instance 14 does not recognize that its data access commands are being monitored by the cache policy optimization layer. Data access commands are received by storage controller 18 and translated for transmission to one or more of the drives of storage enclosure 26.

Storage enclosure 26 includes twenty drives, which are identified as drives D₀ through D₁₉. The drives may be managed according to a RAID storage methodology so that multiple drives or portions of multiple drives are managed as a single logical drive. In this example, drives D₀ through D₁₅ are managed as a first logical drive, and drives D₁₆ through D₁₉ are managed as a second logical drive. In the example of a database application executing on a server node of the network, the first logical drive (D₀ through D₁₅) may include the data files of the database, while the second logical drive D₁₆ through D₁₉ includes the transaction log files of the database. For a typical database, the data files will consume more storage space than the transaction log files of the database.

Each of the nodes 12 are coupled to one another by a communications link 24. Communications link 24 is used for synchronization and polling between the two server nodes. In the event of a failure of a server node or the storage controller, this failure is recognized by the opposite server node across communications link 24 and the applications of the failed server node are failed over or migrated to the alternate server nodes which then assumes ownership over the logical drives previously owned by the failed server node.

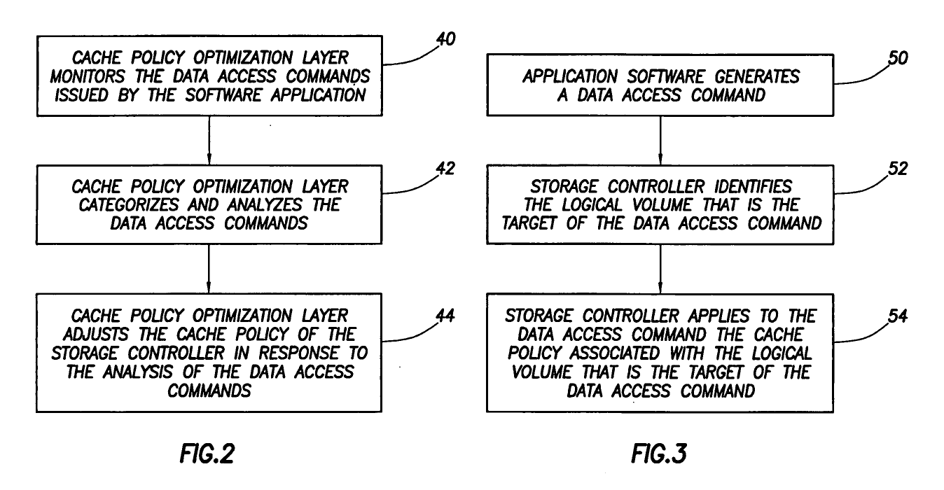

Shown in FIG. 2 is a flow diagram of a series of steps for monitoring the issuance of data access commands and adjusting the cache policy of the storage controller in response. In operation, cache optimization layer 16 monitors at step 40 the data access commands generated by the software application 14. Cache optimization layer 16 monitors the data access commands to determine if the caching policy of the storage controller should be modified in view of the frequency of, type of, or target for the data access commands being generated by the application software. A number of cache policies can be applied to the cache of the storage controller. As an example, with respect to write commands, the storage controller could apply a write-back caching policy in which the data of a write command is written first to the cache and only later flushed to the target location of the write command on the storage drive. The storage controller could use a write-through caching policy in which each write command is written simultaneously or near simultaneously to the cache and to the target location of the write command on the storage drive. In addition, a caching policy could be applied in which all write caching is disabled. With respect to read commands, the storage controller could apply a read ahead cache policy in which a block of data associated with a previous read or write is written to the cache and made available for access in the event of a future read to an address included within the block of data. In addition, a read caching policy could be applied in which all read caching is disabled.

At step 42, cache policy optimization layer 16 categorizes and analyzes the data access commands. The data access commands may be categorized or analyzed according to a number of criteria, including the frequency of the commands, the type of commands, and the storage target for the command. At step 44, the cache policy optimization layer adjusts the cache policy of the storage controller in response to the analyzed data access commands. As an example, the cache policy may be adjusted on the basis of the type of data access commands and the storage target for the commands. In the case of a database application, the data access commands will consist of a first set of data access commands, including write commands, directed to the drives housing the data files of the database and a second set of data access commands, including write commands, directed to the drives housing the transaction log files of the database. Recognizing that the database application is issuing data access commands that comprise commands directed to either the drives of the data files or the drives of the transaction log files, the cache policy optimization layer adjusts the caching policy so that write-back caching is enabled for all writes directed to the transaction log files, and so that write caching is disabled for all writes directed to the data files.

The segregation of the caching policy of the storage controller according to the destination of the command is desirable in some applications due to the nature of the data access commands and the consequence of having uncommitted data upon the failure of the storage controller. Write-back caching can be enabled for write commands to the transaction log files because the write commands to the transaction log files are sequential commands. As sequential commands, the commands must be executed in the order in which the commands were issued. As such, a performance advantage can be gained by storing the write data associated with these commands in the cache before flushing a larger set of data to the storage drives, where the commands can be executed in the sequence in which the commands were received by the storage controller. Although data access commands directed to data files need not be executed sequentially, having uncommitted data in the cache of the storage controller can create a data inconsistency in the event of a failure of the storage controller, as data from certain write commands has not yet been committed to the storage drives. Write caching is thus disabled for write commands directed to the data files. The failure of a server node or storage controller is less problematic in the case of uncommitted data directed to the transaction log files, as this data concerns transaction logs that can be recreated on the basis of the data files following a failure of a server node or a storage controller. This is necessary because there is not any cache coherency between RAID controllers in separate nodes.

Following the adjustment of the cache policy by the cache policy optimization layer, the storage controller implements the cache policy upon the receipt of data access commands. Shown in FIG. 3 is a flow diagram of a series of method steps for implementing a cache policy at a storage controller. In this example, the storage controller is applying a cache policy according to the logical volume associated with the data access command. In this example, write caching is disabled with respect to write commands directed to a logical volume associated with data files of a database, and write-back caching is enabled with respect to write commands directed to a logical volume associated with transaction log files of a database. At step 50, the application software instance generates a data access command to read or write data. Following the receipt of the data access command by the storage controller, the storage controller identifies the logical volume that is the target of the data access command at step 52. At step 54, the storage controller applies to the data access command the cache policy associated with the logical volume that is the target of the data access command. The storage controller applies a cache policy that is set by the cache policy optimization layer.

It should be recognized that the cache policy optimization layer can adjust the cache policy of the storage controller on the basis of factors other than the target logical drive of the data access command. As an example, the cache policy could be adjusted on the basis of the volume of data access requests to a particular logical volume. In the event of a high volume of data access requests to one logical volume, write-back caching could be enabled and the size of the cache could be increased so that the cache would have to be flushed less frequently. The cache policy optimization layer can also work with software applications other than database applications. Depending on the data access commands generated by the software application, the cache policy of the storage controller can be modified to improve the performance of the software application while not compromising the ability of the software application to recover from a failure in the server node or storage controller.

Although the present disclosure has been described in detail, it should be understood that various changes, substitutions, and alterations can be made hereto without departing from the spirit and the scope of the invention as defined by the appended claims.

What is claimed is:

1. A server node, comprising:
a software application;
a storage controller; and
a cache optimization utility, wherein the cache optimization utility monitors data access commands generated by the software application and is operable to modify the cache policy of the storage controller on the basis of one or more characteristics of the data access commands generated by the software application.

2. The server node of claim 1, wherein the operation of the cache optimization utility is transparent to the software application.

3. The server node of claim 1, wherein the cache optimization utility is operable to modify the policy of the storage controller such that the cache policy is dependent upon the storage location that is the target of each respective data access command received by the storage controller.

4. The server node of claim 1, wherein the software application is a database application.

5. The server node of claim 4, wherein the cache optimization utility is operable to modify the policy of the storage controller such that the cache policy involves the application of a first cache policy to data access commands directed to the data files of a database and a second cache policy to data access commands directed to the transaction log files of a database.

6. The server node of claim 4, wherein the cache optimization utility is operable to modify the policy of the storage controller such that the cache policy applies a first cache policy to data access commands directed to a first logical drive of a RAID array and a second cache policy to data access commands directed to a second logical drive of a RAID array.

7. A method for managing the cache policy of a storage controller of a server node, comprising:
monitoring data access commands generated by a software application of the server node, wherein the monitoring of the data access commands occurs in a manner that is transparent to the operation of the software application; and
adjusting the cache policy of the storage controller on the basis of one or more characteristics of the data access commands generated by the software application.

8. The method for managing the cache policy of a storage controller of a server node of claim 7, wherein the software application is a database application.

9. The method for managing the cache policy of a storage controller of a server node of claim 8, wherein the step of adjusting the cache policy of the storage controller comprises the step of adjusting the cache policy of the storage controller such that the cache policy is dependent upon the identity of the storage location that is the target of each respective data access command received by the storage controller.

10. The method for managing the cache policy of a storage controller of a server node of claim 8, wherein the step of adjusting the cache policy of the storage controller comprises the step of adjusting the cache policy of the storage controller such that the cache policy involves the application of a first cache policy to data access commands directed to the data files of a database and a second cache policy to data access commands directed to the transaction log files of a database.

11. The method for managing the cache policy of a storage controller of a server node of claim 8, wherein the step of adjusting the cache policy of the storage controller comprises the step of adjusting the cache policy of the storage controller such that the cache policy involves the application of a first cache policy to data access commands directed to a first logical drive of a RAID array and a second cache policy to data access commands directed to a second logical drive of a RAID array.

12. The method for managing the cache policy of a storage controller of a server node of claim 11, wherein the first cache policy is the disabling of all write caching for data access commands directed to the first logical drive of a RAID array.

13. The method for managing the cache policy of a storage controller of a server node of claim 11, wherein the second cache policy is the application of write-back caching for data access commands directed to the second logical drive of a RAID array.

14. A network, comprising:
a first server node and a second server node, wherein each of the first server node and the second server node comprises,
a software application;
a storage controller; and
a cache optimization utility, wherein the cache optimization utility monitors data access commands generated by the software application and is operable to modify the cache policy of the storage controller on the basis of one or more characteristics of the data access commands generated by the software application;
a communication link coupled between the first server node and the second server node, wherein a software application of the first server node is operable to be migrated to the second server node in the event of a failure in the first server node and wherein a software application of the second server node is operable to be migrated to the first server node in the event of a failure in the second server node; and
a drive array coupled to each of the first server node and the second server node, wherein the drives of the drive array are managed according to a redundant storage methodology.

15. The network of claim 14, wherein the operation of the cache optimization utility of each respective server node is transparent to the software application of each respective server node.

16. The network of claim 14, wherein the cache optimization utility of each respective server node is operable to modify the policy of the storage controller of each respective server node such that the cache policy is dependent upon the storage location that is the target of each respective data access command received by the storage controller.

17. The network of claim 14,
wherein the software application is a database application; and
wherein in a data files and the transaction log files of a database are stored on the drives of the drive array.

18. The network of claim 17, wherein the cache optimization utility of each respective server node is operable to modify the policy of the storage controller of each respective server node such that the cache policy involves the application of a first cache policy to data access commands directed to the data files of the database and a second cache policy to data access commands directed to the transaction log files of the database.

19. The network of claim 17, wherein the cache optimization utility of each respective server node is operable to modify the policy of the storage controller of each respective server node such that the cache policy applies a first cache policy to data access commands directed to a first logical drive of the RAID array and a second cache policy to data access commands directed to a second logical drive of the RAID array.

20. The network of claim 19,
wherein the first cache policy is the disabling of all write caching for data access commands directed to the first logical drive of the RAID array, and
wherein the second cache policy is the application of write-back caching for data access commands directed to the second logical drive of the RAID array.
